(19) United States
(12) Patent Application Publication
(10) Pub. No.: US 2024/0104543 A1
(43) Pub. Date: Mar. 28, 2024

(54) AUDIO MICRO CONTENT MONETIZATION/INTERACTION ENGINE AND METHODS

(71) Applicants: VIGNESH RAMASWAMY, SAN FRANCISCO, CA (US); MADHAN KARKY, CHENNAI (IN)

(72) Inventors: VIGNESH RAMASWAMY, SAN FRANCISCO, CA (US); MADHAN KARKY, CHENNAI (IN)

(21) Appl. No.: 18/129,864

(22) Filed: Apr. 2, 2023

Related U.S. Application Data
(63) Continuation-in-part of application No. 17/583,205, filed on Jan. 25, 2022.
(60) Provisional application No. 63/452,505, filed on Mar. 16, 2023.
(60) Provisional application No. 63/243,100, filed on Sep. 11, 2021.

(51) Int. Cl. G06Q 20/22; G06Q 20/06; G06Q 50/00; G10L 15/04

(52) U.S. Cl. CPC G06Q 20/29; G06Q 20/065; G06Q 50/01; G10L 15/04

(57) ABSTRACT

A computerized method of a platform comprising: providing the platform, wherein the platform comprises a multimedia media content tool/platform that provides a set of functionalities of a user interface; providing a set of platform-based media content; organizing the platform-based media content in a plurality of blocks, wherein each block comprises a set of digital assets on a block level with a set of specified integrations and engagements; with the plurality of blocks: provide a set of block-level interactions, nest one block into another, put a block behind a paywall (e.g. as a fiat/crypto currency or as an NFT, etc.), visually represent the blocks in different parts of the block, create relations between a set of different blocks, add one or more tags to each block, and enable one or more micro-interactions/transactions for the platform-based media content among a plurality of users.

### CLAIM OF PRIORITY

This application claims priority to U.S. Provisional Patent Application No. 63/452,505, filed on 16 Mar. 2023 and titled VIDEO MICRO CONTENT MONETIZATION/INTERACTION ENGINE AND METHODS. This provisional patent application is hereby incorporated by reference in its entirety.

This application is a continuation in part of and claims priority to U.S. patent application Ser. No. 17/583,205, filed on 25 Jan. 2022. This patent application is hereby incorporated by reference in its entirety.

U.S. patent application Ser. No. 17/583,205 claims priority to U.S. Provisional Patent Application No. 63/243,100, filed on 11 Sep. 2021. This Provisional patent application is hereby incorporated by reference in its entirety.

This application is a continuation in part of and claims priority to U.S. Provisional Patent Application No. 63/452,505, filed on 16 Mar. 2023. This Provisional patent application is hereby incorporated by reference in its entirety.

### BACKGROUND

Identity is not static. It can arise from a cyclical interaction of three key elements of the creative process. These can include: creation, monetization, and discovery. In this way, the act of creating cannot be separated from monetizing. For example, monetizing is connected to discovery, and discovery leads to creation. In a way, life is a creator's canvas. Therefore all forms of creation should be presented and engaged with, and the creator should have control over the life potential of their creation. The creator should decide with whom and how to bring their creations to reach their potential. Creative enterprises should be able to work with creators without conflict. Creation, storage, monetization, and discovery should happen in the same place as well.

Today's creator is often disembodied. They take different aspects of themselves to different digital applications. Their creation should not be restricted to one particular domain of discovery. At the same time, the opportunities for creation and monetization of creations are increasing. For example, creators can leverage fiat, crypto and NFT technologies to monetize their multimedia creations on the Internet. Accordingly, improvements to the methods and systems of how creators create, store, monetize, and enable the discovery of the multimedia creations on the Internet are desired.

### SUMMARY OF THE INVENTION

A computerized method for AUDIO micro content monetization is provided. Other content interaction/content micro interactions can be provided as well. AUDIO micro content monetization is performed by an audio micro content monetization engine. The audio micro content monetization engine can be a SaaS engine for creative organizations enabling micro transactions for any small part (e.g. seconds, pixels, minutes, paragraphs, etc.) of a creator's content in any currency of the user's choice (e.g. is currency agnostic). While creators can add pay block of various methods like fiat currency, crypto currency, and ad block, etc. Other users can access the audio micro content by paying only for the pay block applied by the creator. Audio micro content monetization engine provides and manages a SaaS technology platform and ecosystem that enables creators (e.g. individuals, business, other entities, etc.) to build unique and novel monetization avenues and create a sustainable creative business with complete freedom and control in any currency of their choice.

Audio micro content monetization engine can provide ad/subscription business models by creating a third revenue stream for creative organizations. Audio micro content monetization engine solves the monetization problem for creative organizations and creators as an augmentation to the declining subscriptions and advertising model by helping them take charge and create unique and novel revenue channels for their content. Audio micro content monetization engine seamlessly integrates with your system and provides users with a simple one click ability to obtain desired content without waiting.

Audio micro content monetization engine enables micro-monetization SaaS engine which enables micro transactions for any part (e.g. pixels, words, characters in an audio file, seconds, or minutes) of a creator's content in any currency of your choice (e.g. fiat, crypto (including NFT's), ad systems and inventory). In this way, a business or other entity can attract engaged consumers who don't have to wade through subscriptions, sign ups and/or ads. The customers can be provided instant gratification and the ultimate satisfaction of target purchasing.

### BRIEF DESCRIPTION OF THE DRAWINGS

The present application can be best understood by reference to the following description taken in conjunction with the accompanying figures, in which like parts may be referred to by like numerals.

FIG. 1 illustrates an example Platform, according to some embodiments.

FIG. 2 illustrates an example Block process, according to some embodiments.

FIG. 3 illustrates an example schematic view of a Block structure, according to some embodiments.

FIGS. 4 and 5 illustrates an example landing page attributes, according to some embodiments.

FIG. 6 illustrates an example tool kit GUI, according to some embodiments.

FIG. 7 illustrates an example monetization page, according to some embodiments.

FIG. 8 depicts an exemplary computing system that can be configured to perform any one of the processes provided herein.

FIG. 9 illustrates an example process for implementing online multi-media micro transactions, interactions and monetizations, according to some embodiments.

FIGS. 10-19 illustrate example screenshots of various canvas creation steps, according to some embodiments.

FIG. 20 illustrates an example process for managing audio micro content monetization/interaction, according to some embodiments.

FIG. 21 illustrates an example process for the audio-microcontent platform authorization and authentication, according to some embodiments.

FIG. 22 illustrates another example process for implement a canvas audio content, according to some embodiments.

FIGS. 23-30 illustrate an example set of screenshots for implementing an audio micro content monetization/interaction engine and methods, according to some embodiments.

The Figures described above are a representative set and are not an exhaustive with respect to embodying the invention.

### DESCRIPTION

Disclosed are a system, method, and article of manufacture for enabling micro interactions and transactions on fiat, crypto and NFT for multimedia. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Block can be a text word, text paragraph, pixels, audio (e.g. in terms of seconds, minutes, etc.), image (e.g. in terms of pixels), video (e.g. in terms of seconds, minutes, etc.), various multimedia files, etc. Each block can be pushed as fiat currency interaction or as an NFT interaction or as a crypto currency interaction. Blocks can also be micro-interactions in an augmented/virtual reality space too. Blocks can be arranged in parent/child hierarchies. For example, a same block and whole interaction can be done on a parent block or a child block or both. A block can include a set of digital assets on a block level (e.g. word, paragraph, second, pixel, etc.), integrations and engagements. The Block can be used to implement, inter alia: nest one block into another; put a block behind a paywall (e.g. both fiat and crypto); visually represent the blocks in different parts of the canvas; create relations between different blocks; add tags to each block; optional comments, comments under a paywall and reply to threads for different blocks; etc.

Canvas can be a block interaction system on any multimedia. A canvas can comprise a plurality of blocks. A canvas can be used in a creator's webpage space and/or extended to other type of multimedia platforms. These can include virtual-reality spaces, etc. Interactions with canvas elements can be beyond the block level as well. Canvas can include, inter alia:
block level interactions on any type of content;
system for a decentralized, blockchain powered gamification which provides value for the time spent by a creator and consumer for the process of creation and consumption respectively;
a new community currency which will redefine and create a living breathing economy for creators; and
the economic principles of this currency would be driven by its unique interactions (both offline and online) between a creator and consumer. It is noted that a user can add any hyperlink on the Internet inside a canvas as a block. The user can then implement the same block interactions as defined thereto.

CRUD (create, read, update, and delete are the four basic operations of persistent storage. CRUD can be used to describe user interface conventions that facilitate viewing, searching, and changing information using computer-based forms and reports.

Non-fungible token (NFT) is a unit of data stored on a digital ledger, called a blockchain, that certifies a digital asset to be unique and therefore not interchangeable. NFTs can be used to represent items such as photos, videos, audio, and other types of digital files. Access to any copy of the original file, however, is not restricted to the buyer of the NFT.

Podcast is a program made available in digital format for download over the Internet. For example, an episodic series of digital audio files that a user can download to a personal device to listen to at a time of their choosing. Podcasts can be provided in an audio medium and can include video components. Streaming applications and podcasting services provide a convenient and integrated way to manage a personal consumption queue across many podcast sources and playback devices. Podcast search engines can be provided to help users find and share podcast episodes and/or pay blocks of podcast episodes.

Role-based access control (RBAC) is an approach to restricting system access to authorized users. It is an approach to implement mandatory access control (MAC) or discretionary access control (DAC). RBAC can include role-based security operations.

Software as a service (SaaS) is a software licensing and delivery model in which software is licensed on a subscription basis and is centrally hosted. SaaS is also known as on-demand software, web-based software, or web-hosted software. SaaS is considered to be part of cloud computing, along with infrastructure as a service (IaaS), platform as a service (PaaS), desktop as a service (DaaS), managed software as a service (MSaaS), mobile backend as a service (MBaaS), data center as a service (DCaaS), integration platform as a service (iPaaS), and information technology management as a service (ITMaaS).

Example Systems and Methods

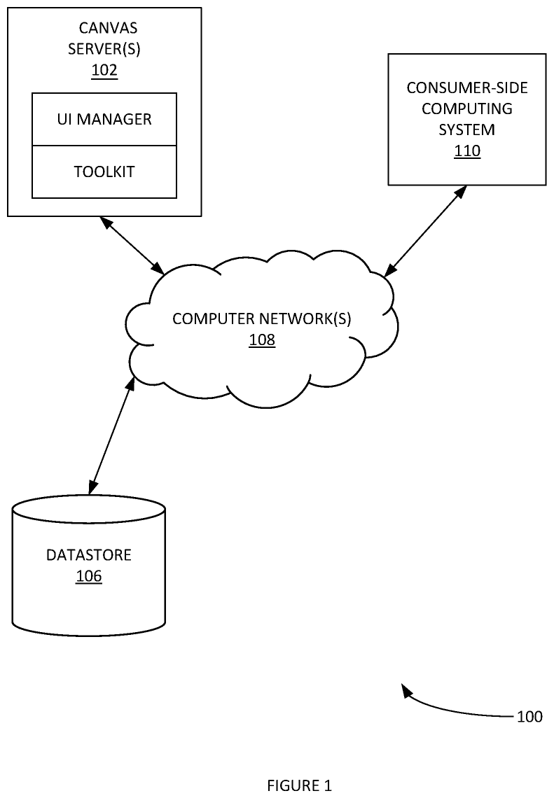

FIG. 1 illustrates an example Platform 100, according to some embodiments. Platform 100 can provide a Canvas for creation, monetization, and discovery. Platform 100 can provide and manage various content interaction/content micro interactions can be provided as well. A Platform/interface can provide the functionalities of a user interface and the data layer through a linear blockchain ledger and a multi model database. As discussed infra, the user interface can be dynamic, evolving, and intuitive. The Canvas UI can provide a high bandwidth and high-fidelity interface to seamlessly transfer a user's thoughts, ideas, and concepts between a creator (e.g. the user) and one or more consumers. Likewise, Platform 100 can enable frictionless micro transactions of content and/or engagement. The user can invent news ways to engage with consumers using the Canvas tools. The Canvas can provide a normalized block chain powered gamified discovery engine that uses an in-app currency for interaction based redeemable rewards as well. Creators/User can structure their content/work/expertise the way they want. For example, a creator can think of monetization before discovery. Platform 100 can utilize various media formats such as, inter alia: text, audio, video, visual, AR/VR, performance-based content, etc.

Platform 100 can also enable collaboration by providing multiple modes for creators to collaborate real time with other creators and even consumers in-app through engagements, content, and integrations. Platform 100 can be a content centric modular environment that allows users of all kinds to extract value out of content while protecting the creators interests. Platform 100 can provide a modular user interface that provides complete freedom for creators to structure their content/work/expertise.

Platform 100 can utilize a relational hierarchy of contents. This content can mimic a mental model of the creator/user enabling consumers to navigate and absorb the content in the most efficient way possible. This can provide new ways for consumers to interact with the creator and their creation and visualize it in a more robust and intuitive way. This can ensure that value is provided for the time spent by creators and consumers for creation and consumption respectively, thereby powering the creative economy.

In some example embodiments, Platform 100 can be utilize an SSR react application with dynamic routing and progressive hydration. A backend can be a mix of Microservices and Serverless functions that interfaces with a NoSQL and/or an RDBMS. All of these will be set up with CI/CD and auto scaling by default. Platform 100 can be optimized for scale and development speed. Platform 100 can use different kinds of databases that are the best fitting for the specified use cases and use an amalgamation of all of these to get the best performance at scale while still being cost-effective. Platform 100 can use a next.js and/or blitz.js based frontend. The SSR be used to increase application speed and dynamic routing. Platform 100 can replicate specified data model(s) as the frontend data blocks can use a NoSQL DB (e.g. MongoDB). Platform 100 can also use an RDBMS (e.g. with a GraphQL layer).

Platform 100 can utilize various microservices system for different APIs. The microservices can utilized various frameworks. The microservices can be containerized and support frictionless porting.

Platform 100 can provide a landing page. The landing page can provide an inline and modular view for the creator post sign up. The creation block can include an editor with style options (e.g. bold/italic/underline, bullets, fonts, highlights, headlines, links, upload image/audio/video, etc.). The landing page can provide various embed link options. Each style mentioned (e.g. in headlines, cover images, etc.) can be represented as individual Blocks. Additionally, Canvas Integrations can be provided.

For a monetization block, a paywall can be maintained. Interaction for content with consumers can be provided. Creators can be provided other filter/public-private-closed toggle functions on the landing page as well. Pay walls can be implemented with a fiat currency/multiple currencies plus an NFT interaction. In some examples, crypto currencies and block chain networks can be utilized to provide payments.

In some embodiments, Platform 100 can enable a user to login into a creation space. The creation space can also provide a toolkit dashboard. An application store can be provided. This can provide access to various content on the Internet for integration into a Canvas. For example, a user/creator can integrate YouTube® videos, WordPress® content, MailChimp®, etc. into a Canvas. Platform 100 can enable a user to co-create a Canvas content as well. Platform 100 can enable searches for other co-creators. Co-creators can split payment on content that is built using a canvas tool. Platform 100 can enable users to create and manage Blocks. Platform 100 can enable the building and management of modular Blocks in the canvas or a sub-canvas.

In one example, a canvas can be a newsletter created simply few a click(s). Platform 100 can then handle the backend. Each monthly newsletter can be a sub-canvas. The canvas and the sub-canvas can be in a parent-child hierarchal relationship. The user can sell any block of content (even to the granular text level) via a paywall. Some content can be behind a pay block and other content can be free.

Platform 100 can enable users to create engagements. An engagement can include a payment/subscription detail, block/content involved, calendaring, etc. This can all be selected with the click of a few button via the canvas interface. Users can add and/or otherwise update engagements as well. Users can block media, paragraphs, etc. in play blocks. Users can be for the full engagement or sub-elements thereof. This can open up new monetization avenues for user at a more granular level of content. Platform 100 can enable adding an NFT to a canvas. With a click of a button a user can create an NFT. Any block can be selected for an NFT. Even a portion of a block can be selected for an NFT.

Platform 100 can manage and provide a creation tool functionality for NFT related media content. This can be used to package an NFT on a block level. Platform 100 can support work by artist, script writers, etc. as use cases. Platform 100 supports pay block and NFT blocks as part of its monetization modalities. Every action on a creator's content can be equated to a value.

More specifically, FIG. 1 shows a Canvas server 102. Canvas server 102 can communicate with consumer-side computing systems 110 via computer network(s) 108. Datastore 106 can be used to store the Canvases, blocks, NFT information, etc.

Platform 100 can manage a discovery system. The discovery system can be a normalized, decentralized discovery system. Creators can define if they want to be part of the discovery system and their level of expertise in the discovery system. The value can be converted into a creator currency as part of the normalized discovery system. Plus or minus signs can be used to designated good or bad content.

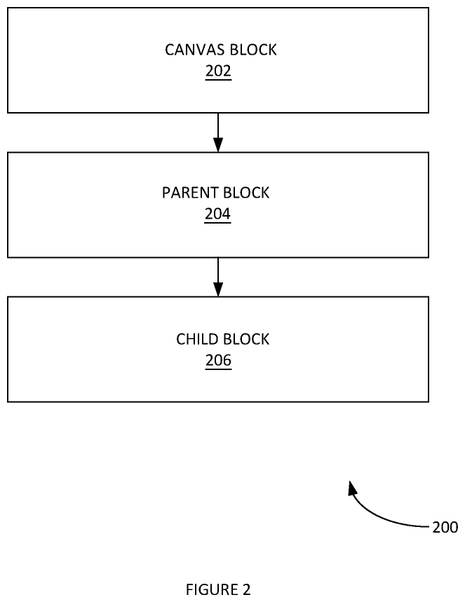

FIG. 2 illustrates an example Block process 200, according to some embodiments. As noted supra, Platform 100 can utilize Blocks 202. Block 202 includes a set of digital assets, integrations, and engagements. Block 202 is a discreet unit of content. Block 202 can be used to perform various actions. These actions can include, inter alia: nest one Block 202 into another; place a Block 202 behind a paywall; visually represent a set of Blocks 202 in different parts of a Canvas; create relations between different Blocks 202; add tags to each Block 202; provide optional comments and reply to threads for different Blocks 202; etc. As shown, Block 202 can be found on a user homepage. Block 202 can have a Parent block 204 and/or Child block 206.

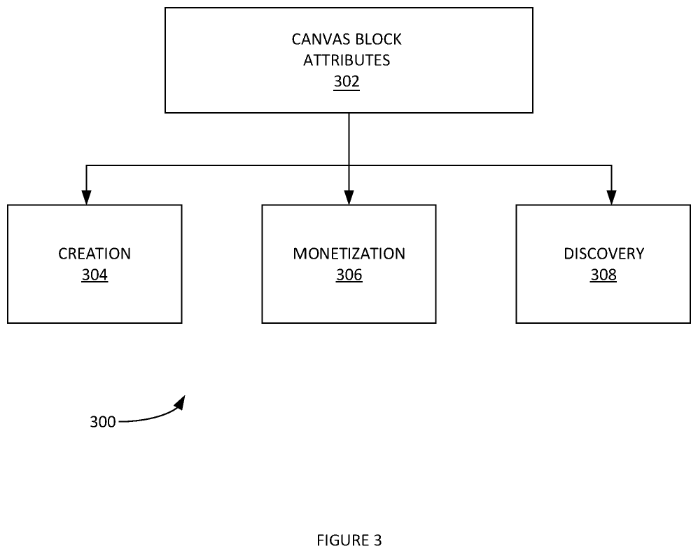

FIG. 3 illustrates an example schematic view of a Block structure 300, according to some embodiments. Various Block attributes 302 can be provided. Creation attributes 304 can be a Block attribute. Creation attributes 304 can include a text-based Block that enables creators to edit long format text-based posts, articles, books, etc. using intuitive text formatting tools. Creation attributes 304 can be a Canvas Image, Video, and Audio blocks. These can enable creators to upload and embed this kind of file with inline previews for the creators and consumers. Creators can set up communities to interact with other creators and/or followers. These communities can also be automatically created upon purchase or subscription. Creators can integrate popular existing tools and platforms to showcase/cross post their work on a Canvas as well.

Monetization attributes 304 can be provided. Creators granularly select the exact piece of content they want to put behind a paywall using the Blocks. Any nested blocks/content can also be unlocked if the parent/root block is unlocked. The creators can separately offer the nested blocks as individual purchases. International transactions can be supported from the get-go using stripe. Creators can setup up multi-tier paywall for the same content using early access, downloads, and any other type of engagement. Creators can also setup fees for Engagement blocks like a one-on-one call, live stream/sessions, consultation, and collaboration.

Discovery attributes 306 can be provided. Discovery can include granular search with filtration and sorting based on time, genre, tags, type of content, etc. Separate showcases can be provided to different types of content. A cluster of Blocks can be displayed in a gallery, carousel, 3D spaces, etc. A currency-based gamification system can be provided as well in a Canvas discovery engine. Additionally, various search functionalities (e.g. image search, Internet search, self-database search, etc.) can be provided.

Example User Interfaces

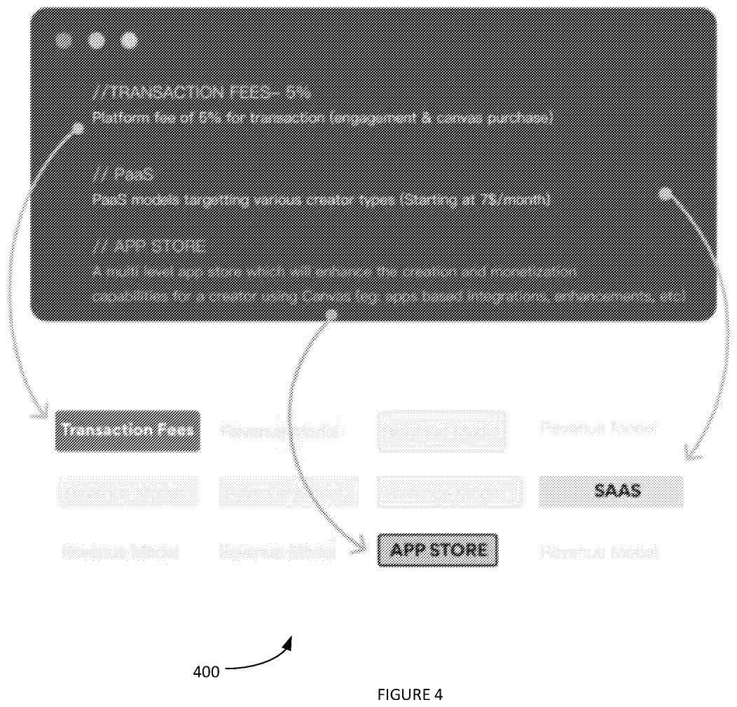

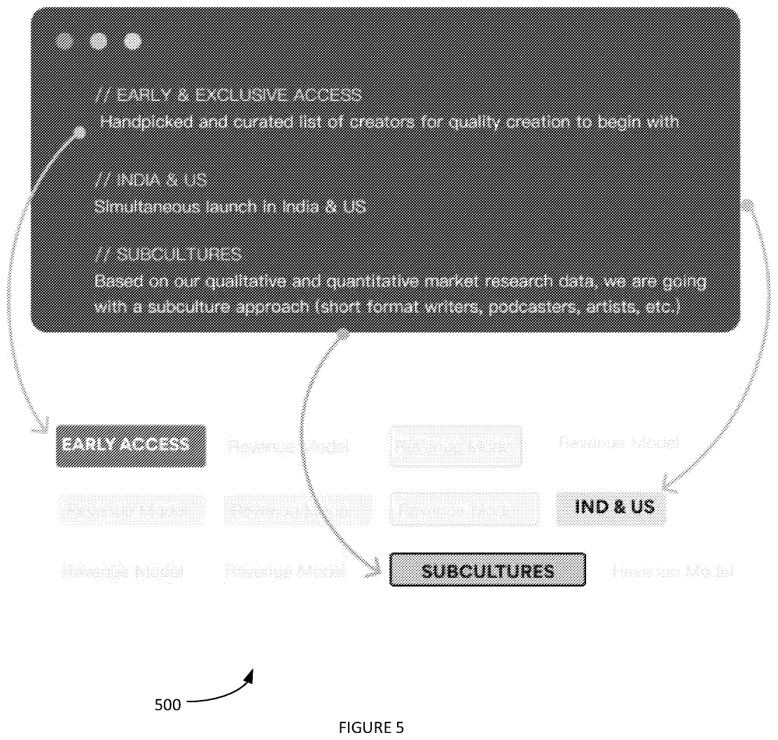

A set of Canvas user interfaces are now provided. FIGS. 4 and 5 illustrates an example landing page attributes 400 and 500, according to some embodiments.

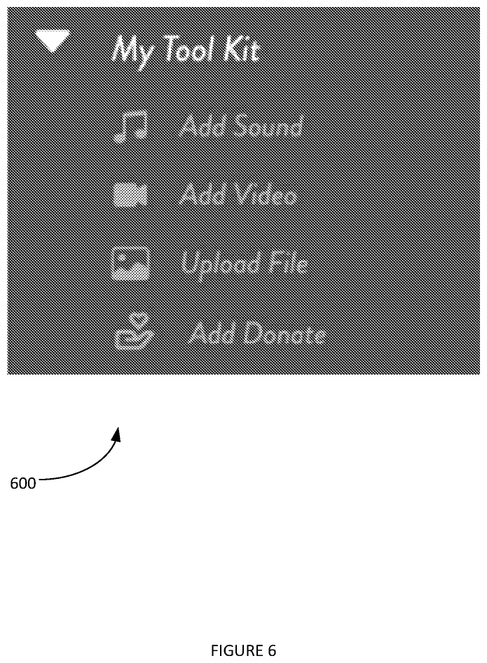

FIG. 6 illustrates an example tool kit GUI 600, according to some embodiments. The tool kit can be used to add, import, and embed rich content including, inter alia: audio, videos, images, pdfs, etc. This can be done in-line on the user's canvas. When a user takes an action on the canvas the Platform 100 manages the technical backend of the operations automatically.

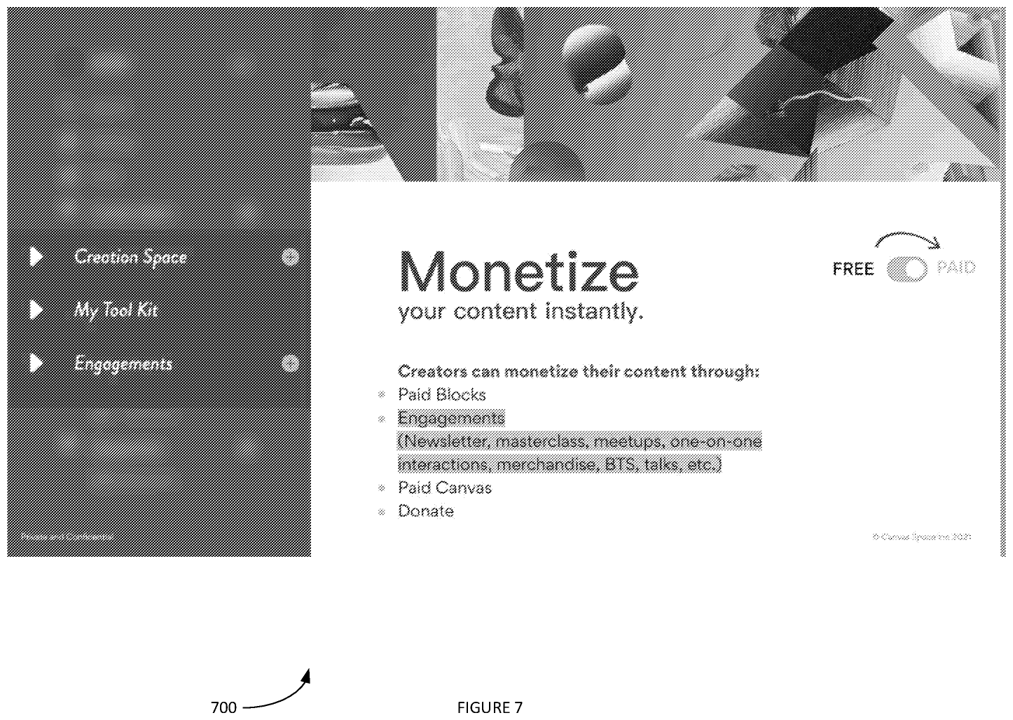

FIG. 7 illustrates an example monetization page 700, according to some embodiments. As shown, the user can toggle between free and paid content generation and/or management.

Additional Computing Systems

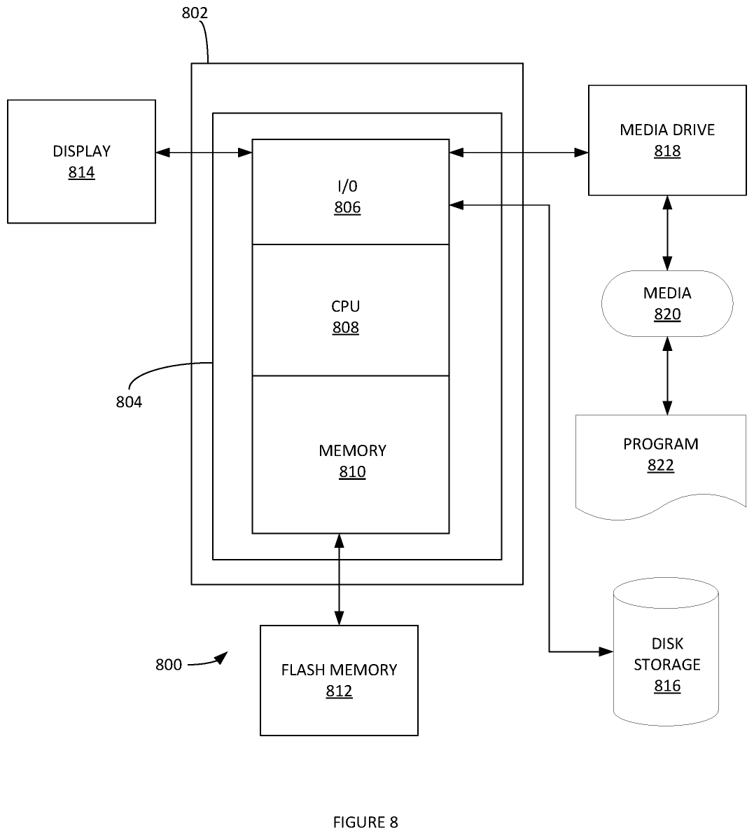

FIG. 8 depicts an exemplary computing system 800 that can be configured to perform any one of the processes provided herein. In this context, computing system 800 may include, for example, a processor, memory, storage, and I/O devices (e.g., monitor, keyboard, disk drive, Internet connection, etc.). However, computing system 800 may include circuitry or other specialized hardware for carrying out some or all aspects of the processes. In some operational settings, computing system 800 may be configured as a system that includes one or more units, each of which is configured to carry out some aspects of the processes either in software, hardware, or some combination thereof.

FIG. 8 depicts computing system 800 with a number of components that may be used to perform any of the processes described herein. The main system 802 includes a motherboard 804 having an I/O section 806, one or more central processing units (CPU) 808, and a memory section 810, which may have a flash memory card 812 related to it. The I/O section 806 can be connected to a display 814, a keyboard and/or another user input (not shown), a disk storage unit 816, and a media drive unit 818. The media drive unit 818 can read/write a computer-readable medium 820, which can contain programs 822 and/or databases. Computing system 800 can include a web browser. Moreover, it is noted that computing system 800 can be configured to include additional systems in order to fulfill various functionalities. Computing system 800 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Additional Discussion of Online Multi-Media Micro Transactions, Interactions and Monetizations

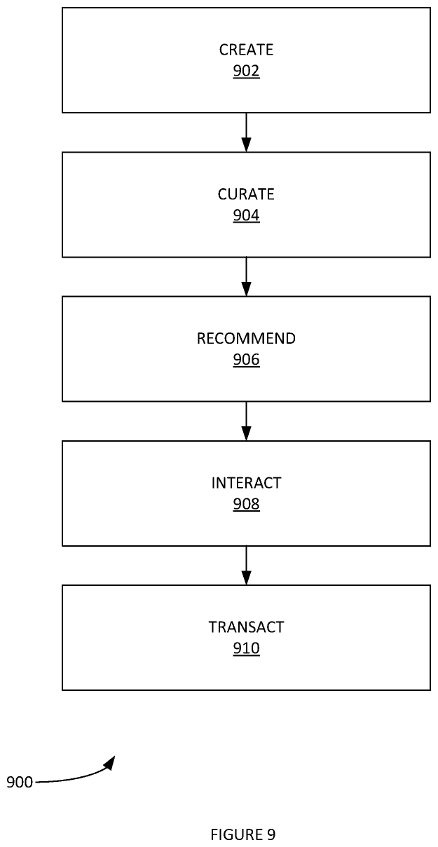

FIG. 9 illustrates an example process 900 for implementing online multi-media micro transactions, interactions and monetizations, according to some embodiments. In step 902, process 900 can implement creation steps. This can include creation of original multi-media content.

In step 904, process 900 can implement a curation step. This can be done via a closed community of Canvas creators and/or via other external sources.

In step 906, process 900 can implement a multi-media content recommendation step. This can be implemented by a multi-content recommendation system. Entities can purchase/pay for the multi-media content they wish to consume.

In step 908, process 900 can implement an interaction step. In this step, users can interact with creators of content within the platform. This can be used to increase consumer interest. A Canvas-currency can be utilized as well.

In step 910, process 900 can implement a transaction step. This can include free multi-media content (e.g. using digital advertisements, free minutes/currency per day or month, etc.). The platform can also offer paid subscriptions. Additionally, users can gift content. As noted elsewhere, micro transaction can be implemented while the user is watching the multi-media content (e.g. can include merchandizing, etc.). It is noted that an AD system can be utilized during the transaction process.

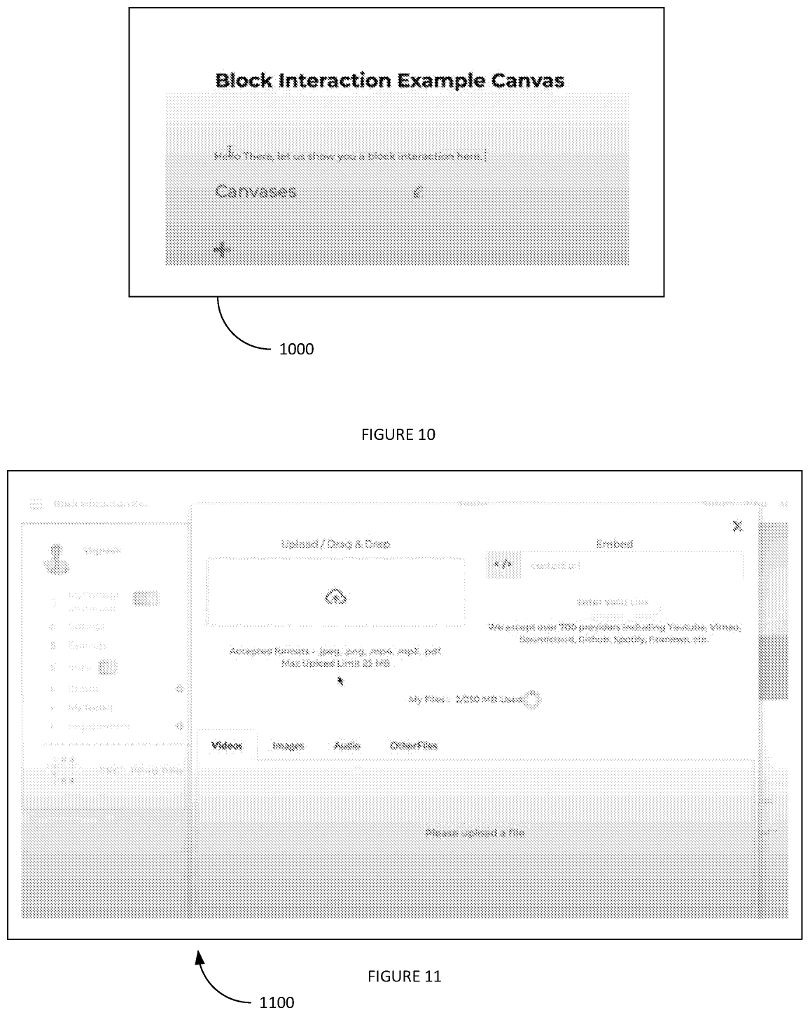

FIGS. 10-19 illustrate example screenshots of various canvas creation steps, according to some embodiments. FIG. 10 illustrates an example screenshot 1000 of a block interaction creation, according to some embodiments. It is noted that a block interaction can include a block. It is noted that a block Interaction can include, inter alia: a pay block, entire canvas lock, NFT (e.g. entire NFT and/or block, etc.), bundle as an engagement, etc.

FIG. 11 illustrates an example screenshot 1100 of an uploading operation during the block interaction creation, according to some embodiments. This operation can be used to obtain/upload the multimedia media content that is linked with the block being created. In example, a content management system of the multimedia media content platform can be used to upload a file that includes the media content.

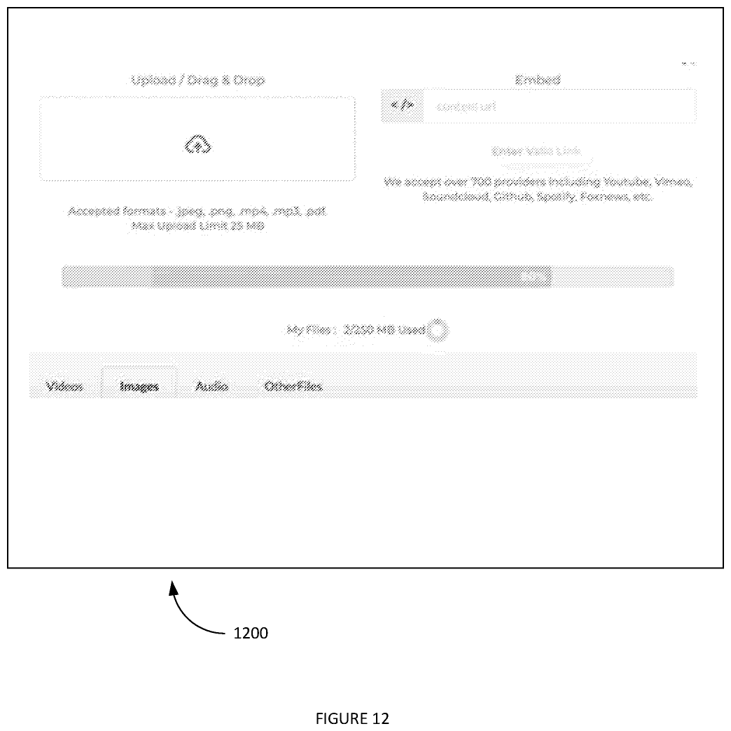

FIG. 12 illustrates an example screenshot 1200 of the uploading operation during the block interaction creation, according to some embodiments. The user interface can show that a digital image is being uploaded by the content management system. A thumbnail view of the digital image can also be gradually presented to the user as the upload operation progresses.

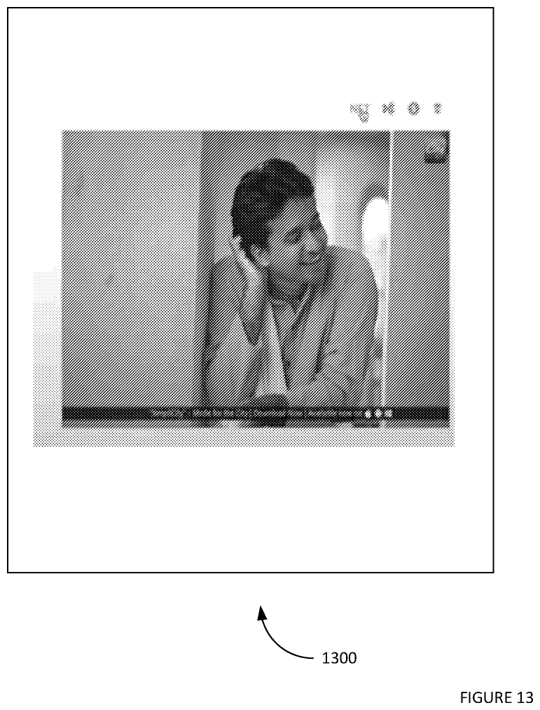

FIG. 13 illustrates an uploaded digital image 1300 that can used as the media content of a block interaction, according to some embodiments. As shown in the screen shot 1300, various virtual buttons are presented to the user. The user can press an ‘NFT’ button to generate an NFT of the digital image. This can be used to generate a pay block (e.g. see infra). The user can press an ‘block’ button to generate a block interaction of a block element in a canvas. Hyperlinks can be embedded in the block interaction. Any hyperlink across the Internet can be embedded and treated as a block. The blocked can optionally be locked. Hyperlinks from the Internet can be pushed as a block inside a canvas.

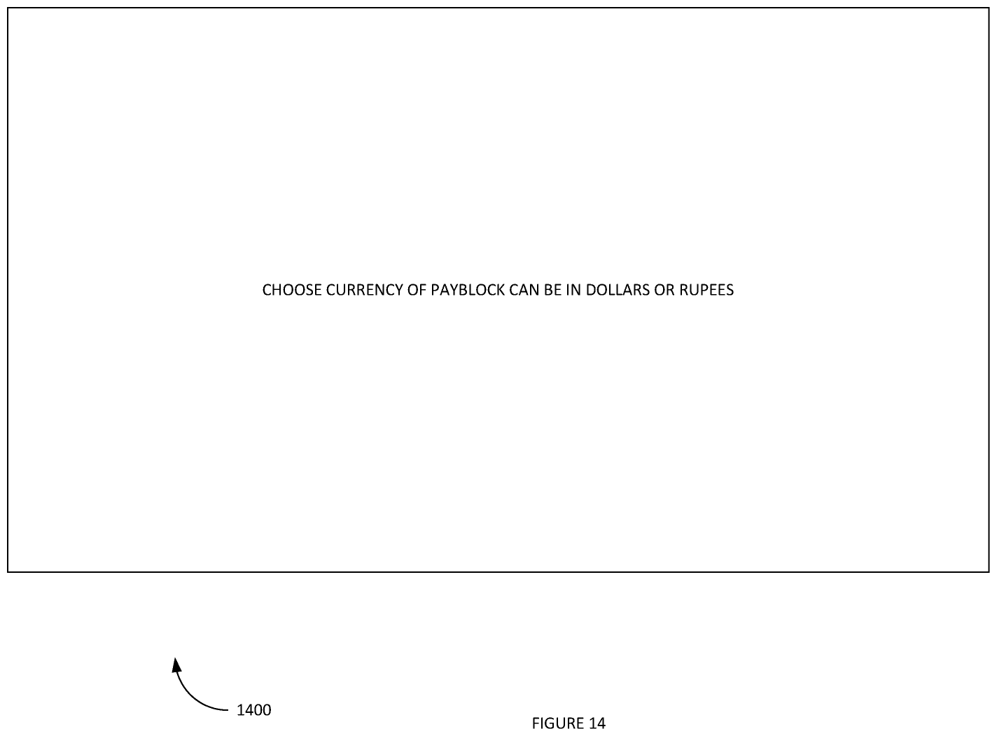

FIG. 14 illustrates an example screen shot 1400 of a pay block generation operation, according to some embodiments. As shown, a pay block can be set according to a specified geography. For example, in the United States the pay block can be set to dollars. In India, the pay block can be set to rupees. An initial NFT value can be set as well. A drop-down menu can be provided to implement these operations. A pay block can be published as a block interaction as well.

In another example, the pay block can be associated with a fiat currency in leu of an NFT.

In order to access the pay block, a user may need to pay a specified amount. In this way, the pay block creator can monetize the media content, etc. associated with the pay block.

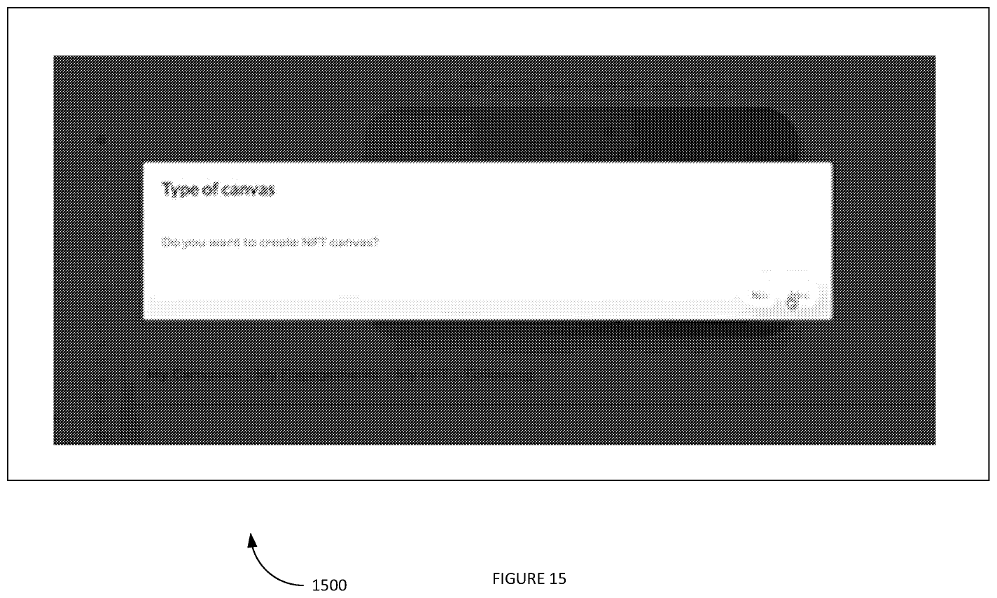

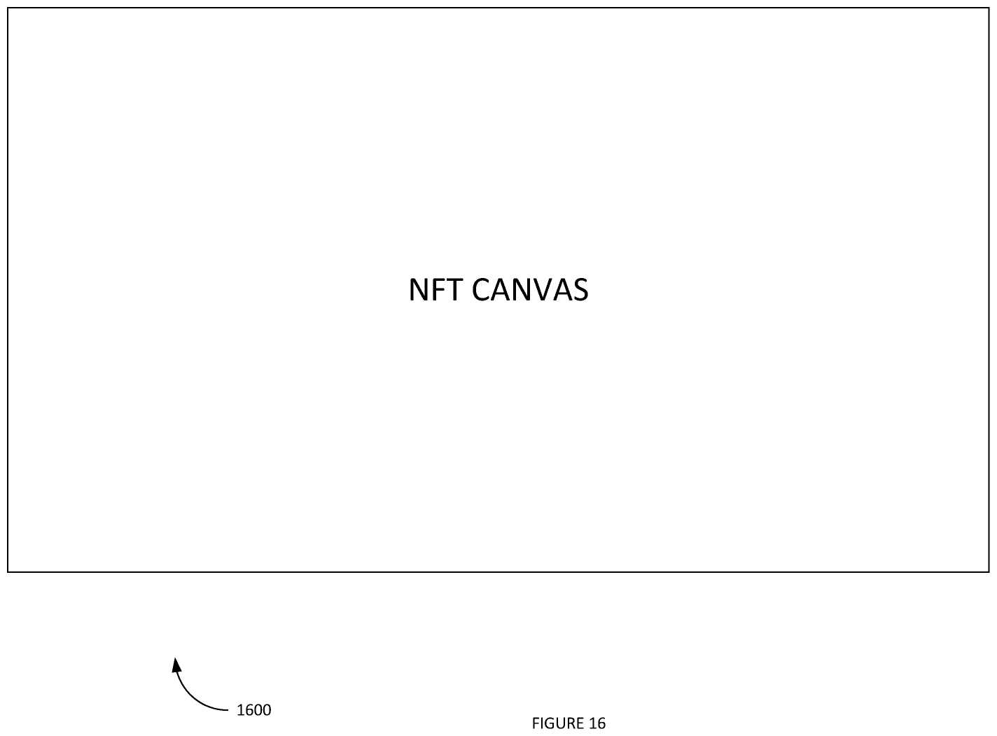

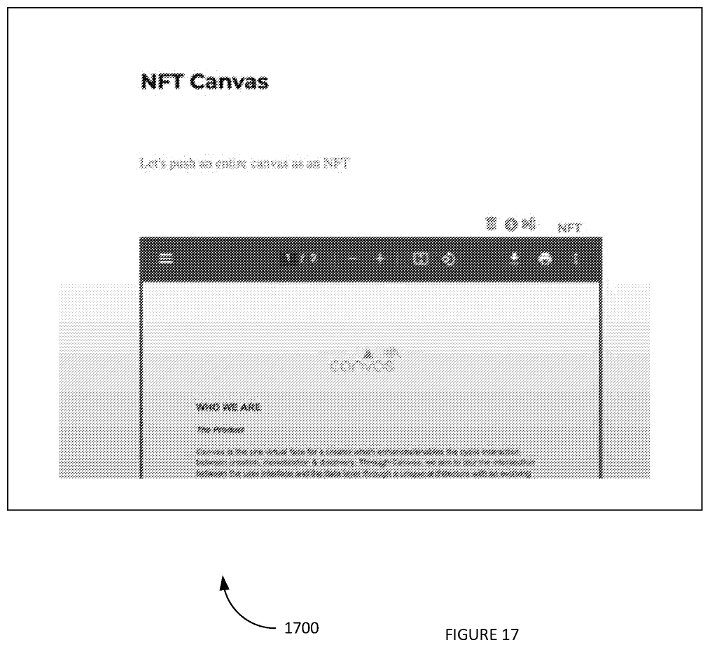

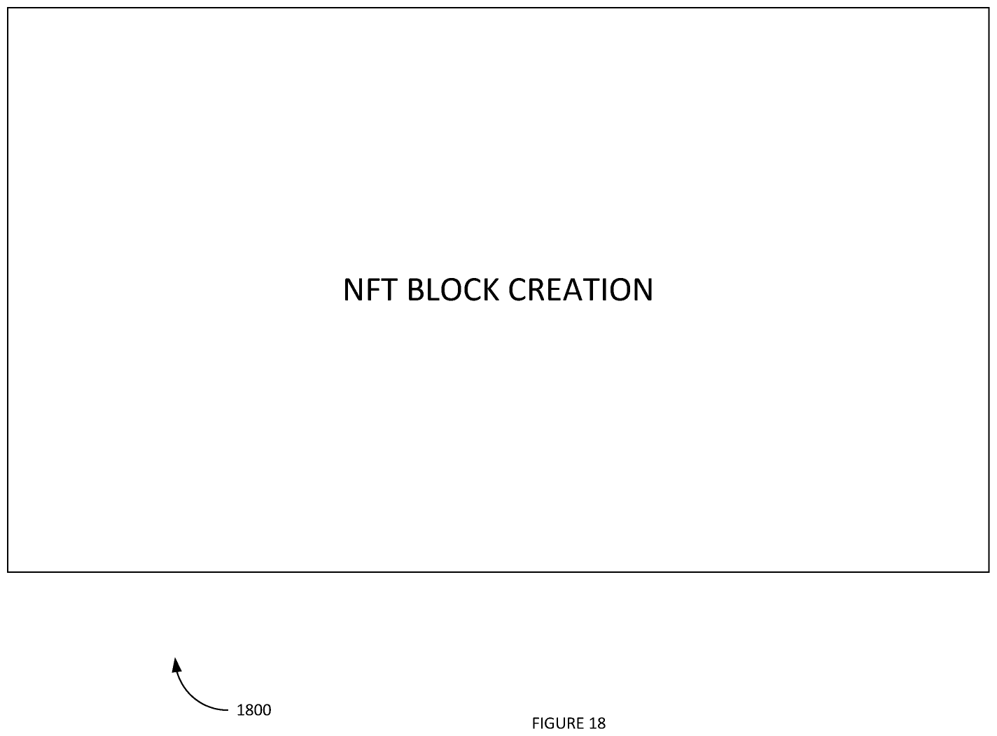

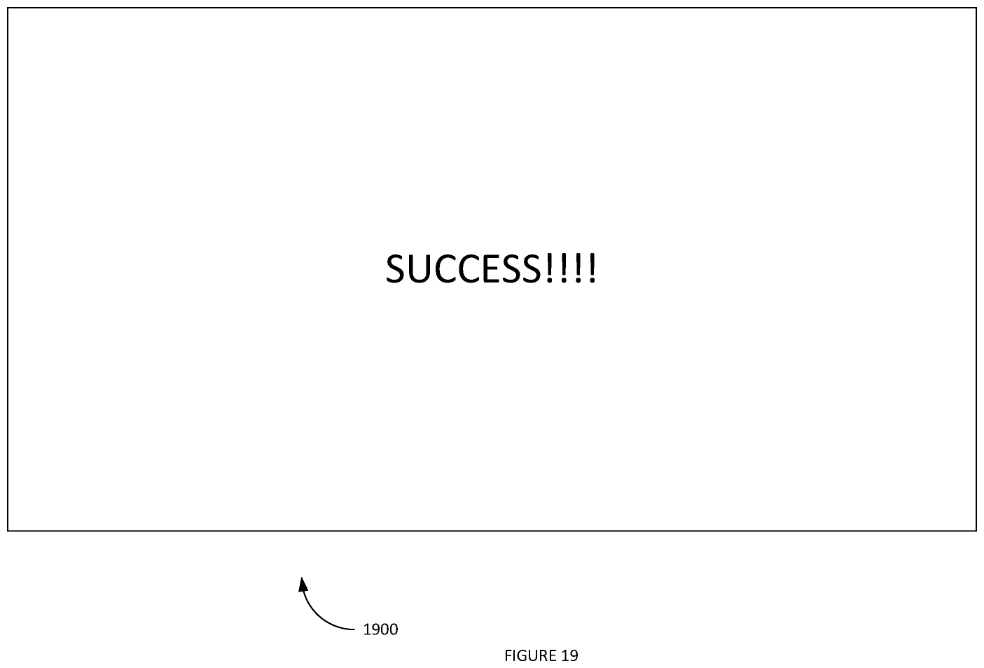

FIGS. 15 and 16 illustrate example screenshots 1500 and 1600 of a canvas generated as an NFT, according to some embodiments. In this example, an audio file can be upload (e.g. in lieu of the digital image discussed in the example supra). FIG. 17 illustrates an example interface 1700 with an NFT generation button, according to some embodiments. The NFT button can be virtually pressed, and the audio file can be transformed into an NFT as shown in FIG. 18, according to some embodiments. Information about the NFT (e.g. file type, artist/creator, title, display name, etc.) can also be uploaded via interface 1700. Media teaser/preview content can also be uploaded. The NFT can be locked as well. When this information is uploaded, the NFT can be minted. The NFT is published and part of the block. It is noted that an entire canvas can be placed in an NFT state as well (e.g. as shown in FIG. 17). FIG. 19 illustrates an alert 2000 that the NFT creation has been successful.

As noted supra, a block can be a text word, text paragraph, audio, image, or a video. Each block can be pushed as fiat currency interaction (e.g. Indian rupee, U.S. dollar, etc.). Each block can be provided as an NFT. A plurality of blocks can be combined into/integrated with a larger canvas of content (e.g. a blog, web page, etc.). This large canvas of content can be pushed as a fiat currency interaction or an NFT interaction as a whole itself.

Audio Micro Content Monetization/Interaction Engine

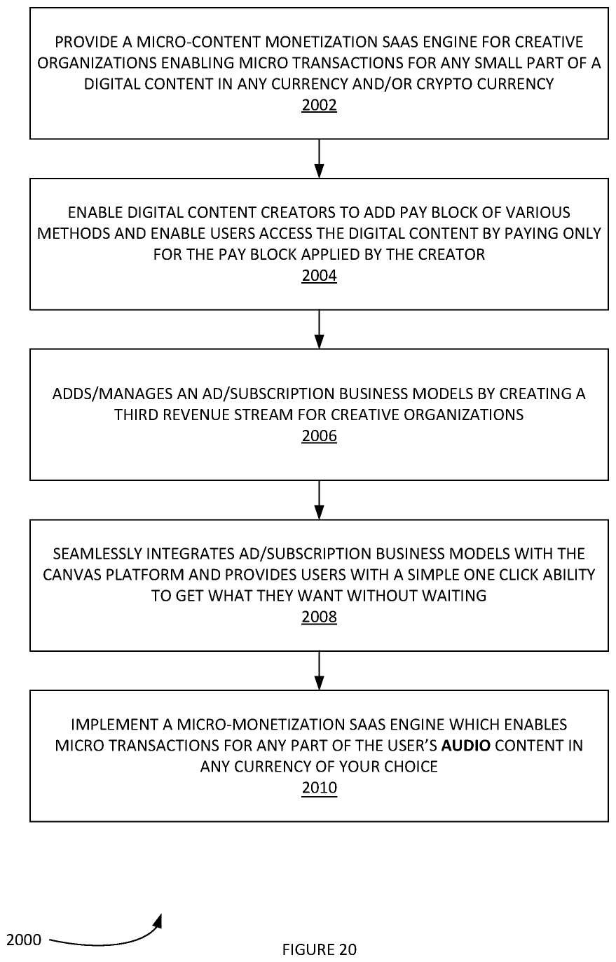

FIG. 20 illustrates an example process 2000 for managing platform audio micro-content monetization/interaction, according to some embodiments. Process 2000 can be implemented by a platform audio micro-content monetization/interaction engine (e.g. platform audio micro-content monetization/interaction infra). In step 2002, process 2000 provides a micro-content monetization SaaS engine for creative organizations enabling micro transactions for any small part (e.g. seconds of an audio file, a set of pixels of an image, minutes of an audio file, paragraphs of a text file, etc.) of a digital content in any currency and/or crypto currency.

In step 2004, process 2000 enables creators to add pay block of various methods (e.g. fiat currency, crypto currency, ad block, etc.). Process 2000 can enable users access the digital content by paying only for the pay block applied by the creator. In this way, process 2000 can provide a SaaS technology platform and ecosystem that enables creators (e.g. both user creators and creative businesses) to build unique and novel monetization avenues and create a sustainable creative business with complete freedom and control in any currency of their choice.

In step 2006, process 2000 adds/manages an ad/subscription business models by creating a third revenue stream for creative organizations. It solves the monetization problem for creative organizations and creators as an augmentation to the declining subscriptions and advertising model by helping them take charge and create unique and novel revenue channels for their content. In step 2008, process 2000 seamlessly integrates ad/subscription business models with the Platform and provides users with a simple one click ability to get what they want without waiting. In step 2010, process 2000 implement a micro-monetization SaaS engine which enables micro transactions for any part (e.g. seconds and/or minutes of an audio file, portions where a specific speaker in speaking during a podcast, portions where specific topic is discussed in a podcast, etc.) of the user's video content in any currency (e.g. Fiat, Crypto (including NFT's), ad systems and inventory).

Businesses become engaged consumers who do not have to wade through subscriptions, sign ups or ads; customers get instant gratification and the ultimate satisfaction of target purchasing.

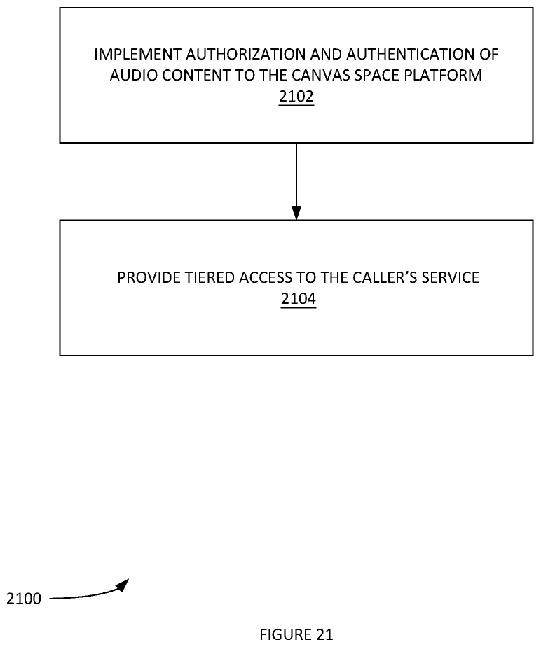

FIG. 21 illustrates an example process 2100 for the audio-microcontent platform authorization and authentication, according to some embodiments. In step 2102, process 2100. implements authorization and authentication of audio content to the platform

In step 2104, process 2100 provides tiered access to the caller's service. Here, process 2100 can implement, inter alia RBAC; CRUD (e.g. create, read, upload, delete from multiple content sources (Audio/Video/Image/Text/Web/Embed); etc. Process 2100 can also manage micro content interactions and micro content monetizations. Process 2100 can provide/manage multi-tiered payment options (e.g. Fiat, Crypto including NFTs, ad inventory and systems, etc.). Process 2100 can enable co-creation and/or co-payments as well between a plurality of user. These can be based on the access control o Integrations with third party services.

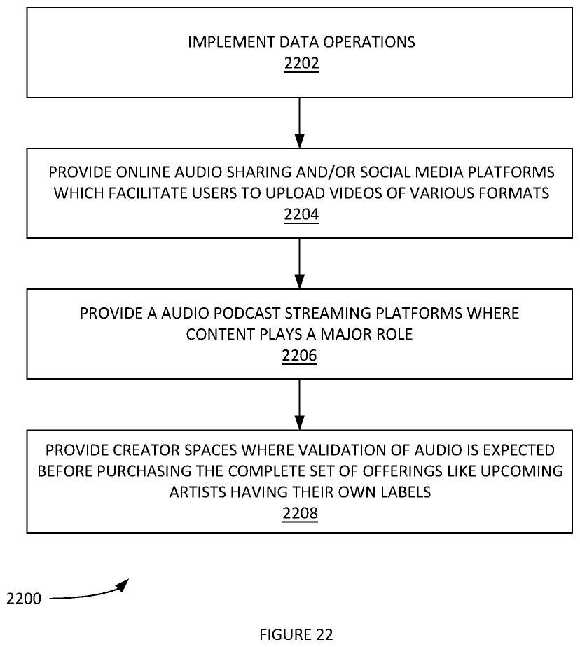

FIG. 22 illustrates another example process for implement an audio micro content, according to some embodiments. In step 2202, process 2200 can implement data operations. A platform can support micro interactions and/or micro monetizations on various formats of audio that the creator space can depend on. Various supported audio types can include, inter alia: M4A, MP3, MP4, WAV, WMA, AAC, FLAC, HLS and DASH or m3u8, rtmp, srt for direct streaming, etc. The Audio file can be submitted either as an upload from the file system or recording through the platform. The submitted Audio can then be marked for the pay block which can be monetized either with a fiat currency, Crypto currency, or Ad Block.

The security aspects can depend on the type of content being uploaded. The platform supports DRM based content, smart URLs (expirable links). The audio is saved on secure storage buckets with its own replication lifecycles. From API/SaSS perspective, Platform supports audio to be uploaded to various sources like Onedrive, S3, BLOB, Minio S3, SFTP/FTP. A media server can implement media transcoding, managing locked content, etc. The media servers of the Platform are capable of transcoding the source audio into various formats including FLV, mp3, mp4, HLS and DASH or m3u8, rtmp, srt for direct streaming. The media server converts all practical file sizes and generates respective counterparts of free vs paid output files which can be leveraged through the authorizations maintained by the audio-microcontent platform.

The Platform can implement a paywall on the data. The Platform can provide full monetization systems. The complete audio uploaded can be put behind a paywall which the users can access by paying for the full content.

The Platform can implement micro monetization. Micro monetization is the most crucial concept of the audio-microcontent platform. A user can select just a part of an audio and put it behind a pay block. The users who wish to access the content (e.g. listen to a music file, download a portion of a song, download a portion of a podcast, etc.) are free to view and listen to the part which are not behind a pay block. However, the content behind pay block can be accessed only after paying through the payment methods imposed by the creator (e.g. as provided by the platform). This can be either in fiat currency and/or crypto currencies (e.g. Ethereum or Bitcoin or any other crypto currency).

The Platform can implement ad-based monetization. The audio content (e.g. full or part) can be unlocked by watching a short advertisement. The ads can be sourced from the existing ad inventories. The audio pay unblock can be unlocked once per ad watch.

In step 2204-2208, process 2200 can implement various use cases. In step 2204, process 2200 can provide online audio sharing and/or social media platforms which facilitate users to upload audio files of various formats. In step 2206, process 2200 can provide an audio podcast streaming platforms where content plays a major role. Strategic placement of the pay block increases the value of each of the podcasts can be provided. In step 2208, process 2200 can provide creator spaces where validation of audio is expected before purchasing the complete set of offerings like upcoming artists having their own labels.

In some examples, the platform can implement audio generation and/or other content generation through AI tools, packages or services (e.g. BARD+ChatGPT). The platform can provide auto title generation based on type of content added. The platform can implement a plagiarism check and content trend analysis. The platform can implement text auto correction with integrations. The platform can implement text editing capabilities by auto suggestions. The platform can provide blog/paid content through plugins for blogs for direct monetization of text. The platform can provide embedded posts which can be shared over various platforms.

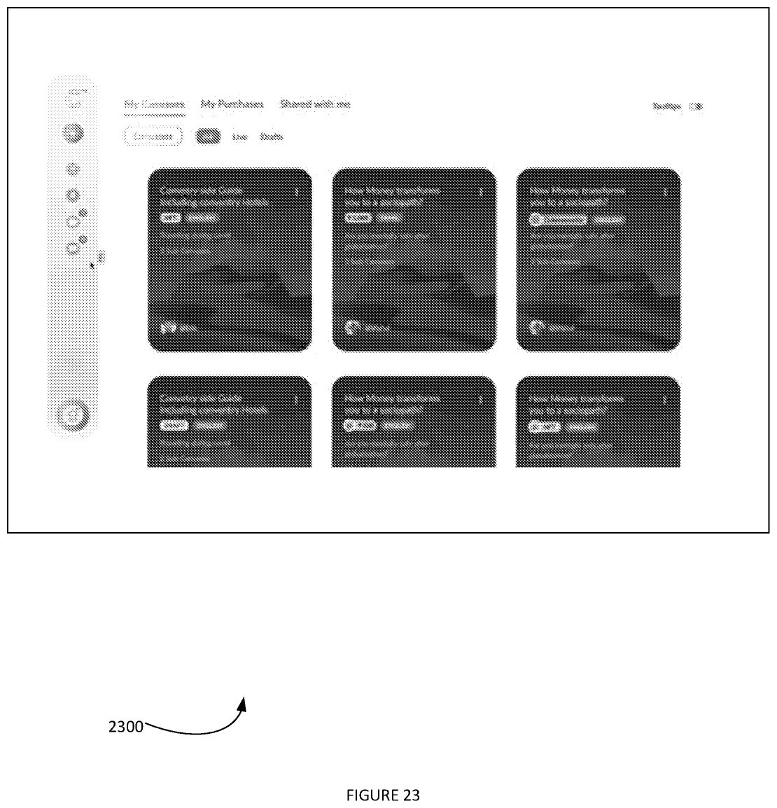

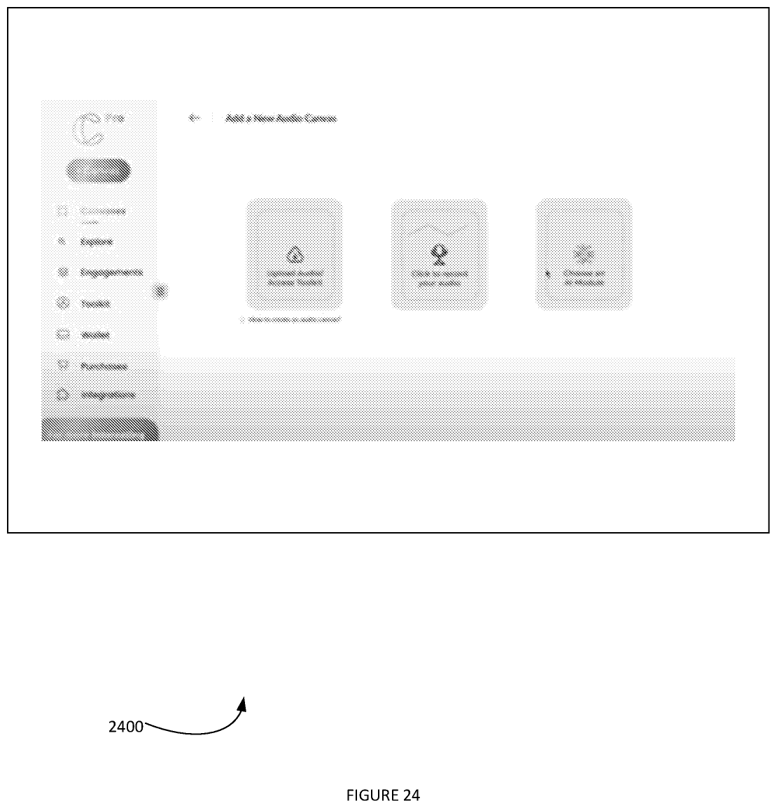

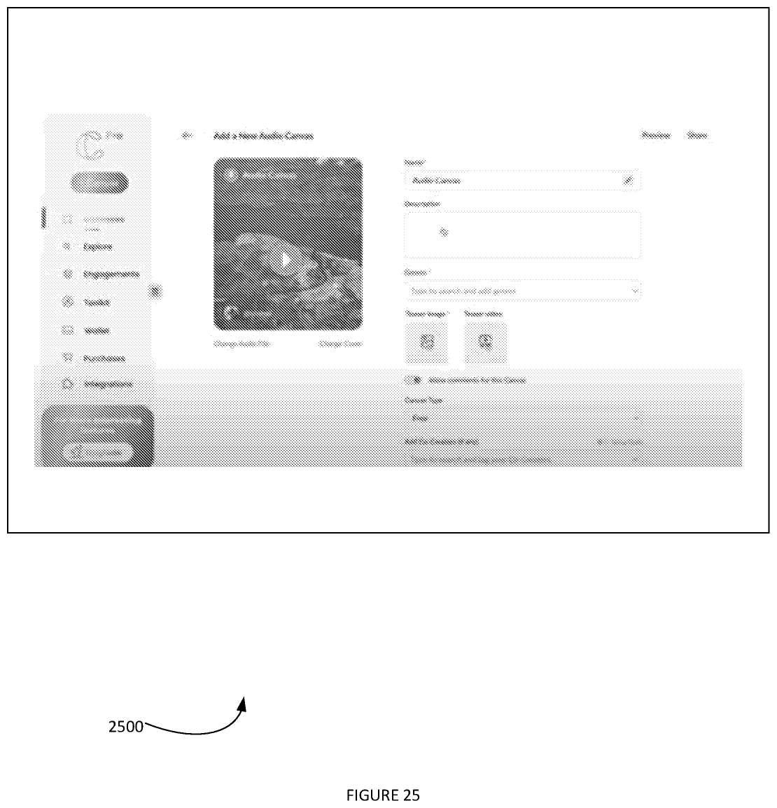

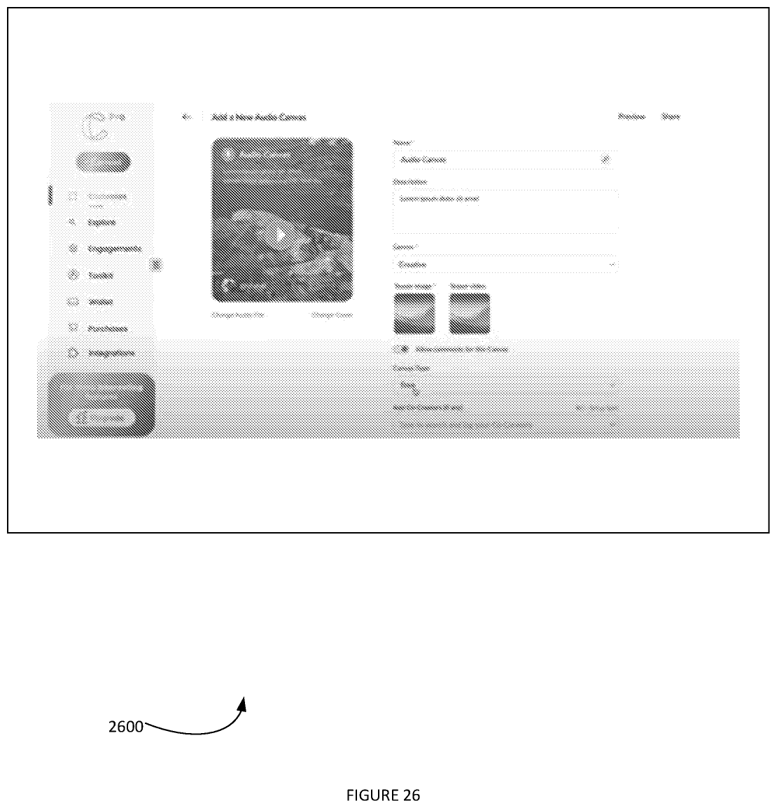

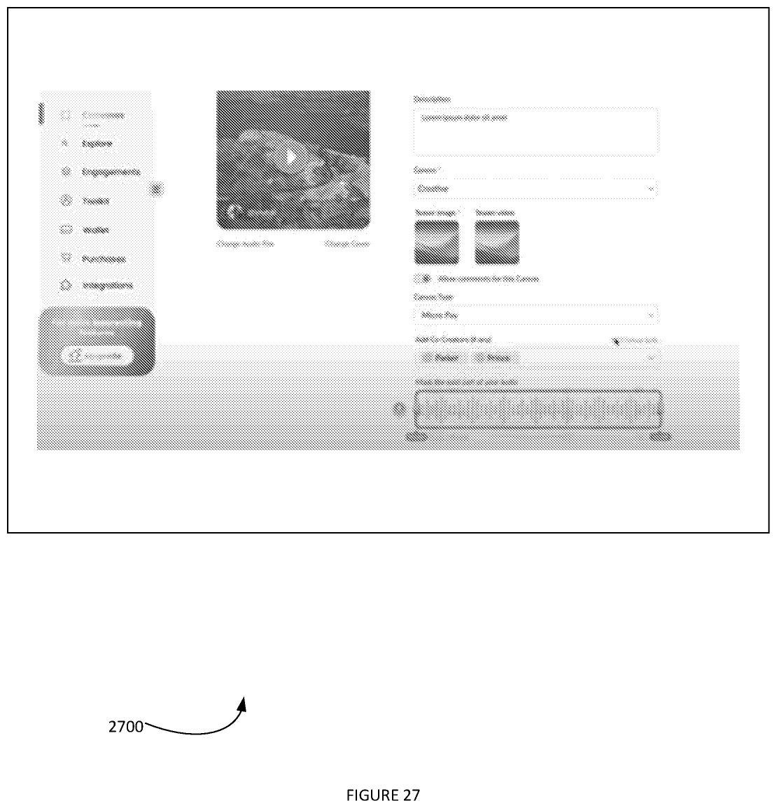

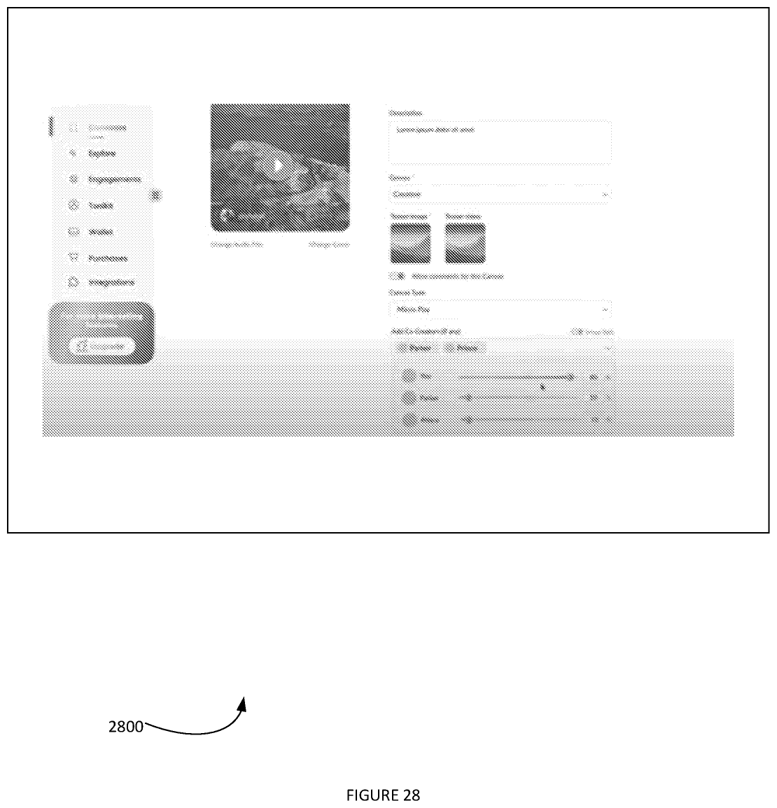

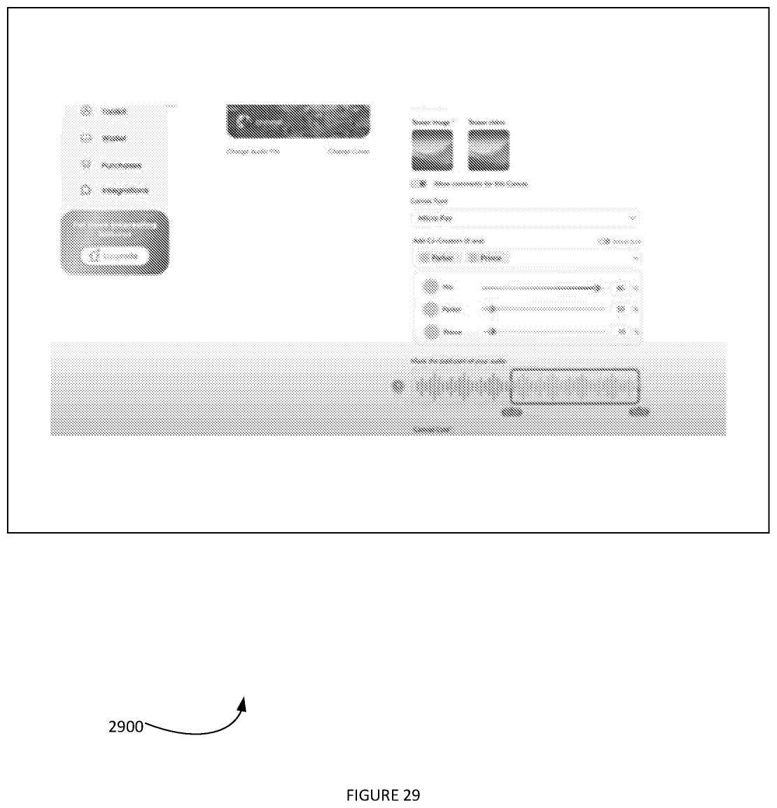

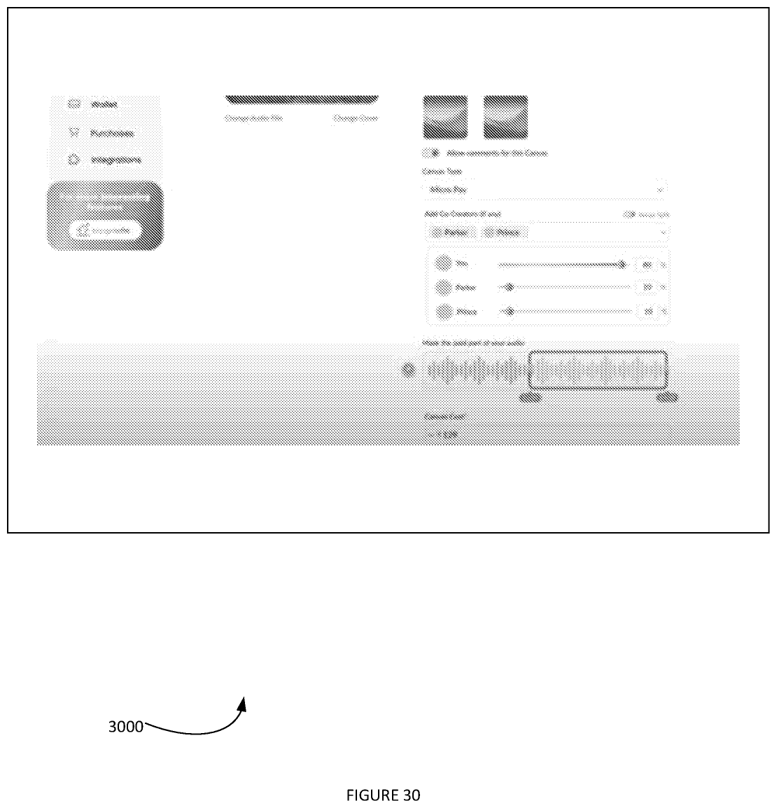

FIGS. 23-30 illustrate an example set of screenshots 2300-3000 for implementing an audio micro content monetization/interaction engine and methods, according to some embodiments. As shown in screenshots 2300-3000, an audio-microcontent platform supports micro interaction and micro monetization on various formats of audio that a creator space can depend on. An audio-microcontent platform can support various audio types (e.g. Mp3, WAV, Mp4, FLAC, MPEG, etc.). The audio can be submitted either as an upload from the file system or recording through the audio-microcontent platform. The submitted audio can then be marked for the pay block which can be monetized either with a fiat currency, Crypto currency or Ad Block. The audio-microcontent platform can implement various security measures. The security aspects can depend on the type of audio content being uploaded. For example, the audio-microcontent platform can provide DRM based content, smart URLs, etc.

In an example use case, the Audio streaming and Media service providers where an audio can be sold as a “pay and use” or “micro pay and use” concept. The audio-microcontent platform can provide podcast streaming platforms. The audio-microcontent platform enable the placement of the pay block increases the value of each of the Podcasts. The audio-microcontent platform can provide creator spaces where validation of audio is expected before purchasing the complete set of offerings like upcoming artists having their own labels

The audio-microcontent platform provide Al based Audio cleansing and noise filtering (e.g. via integration of solutions like Krisp.ai, podcastle.ai, etc.). The audio-microcontent platform can provide Al based voice generation (e.g. via integrations like Murf, Play.ht). The audio-microcontent platform can provide transcriptions of Audio, LIVE subtitles, etc. The audio-microcontent platform provide audio pay block suggestions. The audio-microcontent platform can provide suggestion of best strategic placements of pay block using specified AI models. The audio-microcontent platform include audio tools to trim, enhance, add effects, or superpose audio files. The audio-microcontent platform can provide an audio playlist feature for production houses and podcast creators.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized method of a platform for audio micro content monetization comprising:
providing the platform, wherein the platform comprises a multimedia media content platform that provides a set of functionalities of a user interface;
providing a set of platform-based audio content, wherein the set of platform-based audio content provides an online audio sharing or social media platforms which facilitate users to upload audios of various formats, wherein the set of platform-based audio content provides an audio podcast streaming platforms where content plays a major role;
organizing the platform-based audio content in a plurality of blocks, wherein each block comprises a set of digital assets on a block level with a set of specified integrations and engagements;
with the plurality of blocks:
provide a set of block-level interactions,
nest one block into another,
put a block behind a paywall,
visually represent the blocks in different parts of the block,
create relations between a set of different blocks,
add one or more tags to each block, and
enable one or more micro-transactions for the platform-based audio content among a plurality of users.

2. The computerized method of claim 1, wherein the multimedia media content platform allows a set of users to extract value out of content while protecting the set of creators' interests.

3. The computerized method of claim 1, wherein each block is merged into a user's home webpage.

4. The computerized method of claim 1, wherein each block comprises a parent block and a child block.

5. The computerized method of claim 1, wherein with the plurality of blocks comprises optional comments, comments under a paywall and reply to threads for different blocks;
etc.

6. The computerized method of claim 1, wherein the paywall comprises a crypto-currency based paywall services.

7. The computerized method of claim 1, wherein the platform-based multimedia content comprises a audio performance-based content.

8. The computerized method of claim 1, wherein the block level comprises a pixel level.

9. The computerized method of claim 8, wherein the multimedia media content platform provides a set of frictionless micro transactions of the platform-based media content.

10. The computerized method of claim 9, wherein the block level interactions can be implemented on any type of platform-based audio content.

11. The computerized method of claim 10, wherein the multimedia media content platform comprises a provision for integration or custom implementation of blockchain powered platform that provides value for a time spent by a creator and a consumer for a process of consumption.

12. The computerized method of claim 11, wherein the multimedia media content platform provides a community crypto-currency.

13. The computerized method of claim 14, wherein the multimedia media content platform decentralized advertisement and multi content interaction and discovery system.

14. The computerized method of claim 13, wherein the multimedia media content platform utilizes a relational hierarchy of the platform-based audio content.

15. The computerized method of claim 14, wherein the platform-based audio content mimics a mental model of the creator that provides a navigation model for a consumer to navigate and absorb the platform-based audio content.

16. The computerized method of claim 15, wherein the complete audio uploaded can be put behind a paywall which the users can access by paying for the full content.

17. The computerized method of claim 15, wherein the user selects a part of an audio file and puts the part of the audio behind the pay block.

18. The computerized method of claim 15,
wherein the complete audio is uploaded put behind a paywall which the users can access by paying for the full content, and
wherein the set of platform-based audio content provides a plurality of creator spaces where validation of the audio content is expected before purchasing the complete set of offerings like upcoming artists having their own labels.

19. An audio file micro content monetization method comprising:
providing an audio micro content monetization engine, wherein the audio micro content monetization engine comprises a SaaS engine that performs:
receiving an audio content from a creator entity;
enabling the creator entity to select a smaller portion of the audio content to transform it into a audio micro content;
for the creator entity, enabling a micro transaction for the micro audio content in any currency of a user's choice;
adding a pay block to the micro audio content to implement the micro transaction; and
enabling the user to access the audio micro content by paying only for the pay block applied by the creator.

20. The method of claim 19,
wherein the micro audio content comprises a subset of seconds or pixels of the audio content,
wherein the any currency o the user's choice comprises a fiat currency, a crypto currency, and an ad block, and
wherein the audio micro content monetization engine provides and manages a SaaS technology platform and ecosystem that enables to build unique and novel monetization avenues and create a sustainable creative business with complete freedom and control in any currency of their choice.
